(19) United States
(12) Patent Application Publication
(10) Pub. No.: US 2024/0011317 A1
(43) Pub. Date: Jan. 11, 2024

(54) NOVEL SHADING SYSTEM

(71) Applicant: Anai GREEN, Tel-Aviv (IL)

(72) Inventor: Anai GREEN, Tel-Aviv (IL)

(21) Appl. No.: 18/023,487

(22) PCT Filed: Sep. 13, 2021
(86) PCT No.: PCT/IL2021/051109

§ 371 Date: Feb. 27, 2023

Related U.S. Application Data
(60) Provisional application No. 63/078,564, filed on Sep. 15, 2020.

(51) Int. Cl. E04H 15/10; F03D 9/11; F03D 9/34; F21S 9/03; F21V 23/04; F21S 9/04; H02S 30/20; H02S 40/38

(52) U.S. Cl. CPC E04H 15/10; F03D 9/11; F03D 9/34; F21S 9/035; F21V 23/0471; F21S 9/043; H02S 30/20; H02S 40/38

(57) ABSTRACT

The present invention relates to flexible shading systems that can also provide illumination during nighttime independently from a main power grid.

### FIELD OF THE INVENTION

The present invention relates in general to shading systems, more particularly, to shading systems that comprise flexible shading surfaces equipped with energy collection modules and illuminating units.

### BACKGROUND

Various shading systems and sunshades have been developed during the years but they suffer from various drawbacks and disadvantages. For instance, the most common systems involve a shading sheet spread over the desired area to be shaded. Other systems use folding blinds to control the amount of shade according to need and sun angle, but they require sophisticated and expensive preparation and framing, a mechanical technology, and often require to be connected to an external power source.

Various shading systems have been developed to meet specific needs, such as intelligent shading systems that can monitor the sunlight's angel and adjust the angle/direction of the shad accordingly, modular shading systems that can fit any area, fixed shading systems, e.g. for patios and a parking lot, and flexible shading systems, e.g. for playgrounds.

Furthermore, it is often the case that the same space that requires shading during day time requires illumination during night. Thus, a separate system is required for illuminating the same area.

### SUMMARY

The present invention provides a flexible shading and illumination system (100) for shading and illuminating an area below, the system (100) comprising: (a) at least one flexible shading sheet (101); (b) at least one flexible illumination module (102) attached-to or embedded-within said at least one flexible shading sheet (101), and designed to illuminate said area below the shading system; and (c) at least one green-energy collecting module (103) designed to absorb environmental energy and convert same to electrical energy for powering said at least one illumination module, wherein said shading system (100) is designed to provide shade during daytime and illumination during nighttime without being connected to a power grid.

### BRIEF DESCRIPTION OF DRAWINGS

FIGS. 1A-1C are illustrations of a shading system according to the invention: FIG. 1A is a 3-dimensional illustration; FIG. 1B is an enlargement side-view of the flexible shading sheet; and FIG. 1C is an illustration of the foldability the shading system, showing it in a closed/folded-state.

FIG. 2 is a flowchart illustrating the interactions between the different components in the system.

FIGS. 3A-3B are illustrations of two possible configurations of a shading system according to the invention: FIG. 3A is of a flexible sheet that is connected via its four corners; and FIG. 3B is of a flexible sheet stretched on a frame.

FIG. 4 illustrates a side-view enlargement of a shading sheet according to some embodiments of the invention.

FIGS. 5A-5B are illustrations of the shading- and illumination areas underneath the shading system of the invention, in accordance with sun angle.

FIGS. 6A-6D schematically illustrate different options for coupling a shading sheet, solar-based green-energy collecting modules, and illumination modules with electricity conducting assemblies.

FIGS. 7A-7B illustrate two possible aerodynamic constructions of the shading system according to the invention.

### DETAILED DESCRIPTION

The present invention is aimed at providing shading systems that in addition to their ability to provide shade during the day, can also provide illumination during the night/darkness without needing to be connected to a main power grid.

Today, many municipalities aim to provide shaded walking areas and shaded playing grounds to assist their citizens by providing them refuge from the cupping sun during the day. In addition, they provide streetlights to illuminate these areas during the night.

In the era of environmental awareness, people are aware of issues such as emissions causing global warming, light pollution and air and environmental pollution. As such, many individuals, as well as municipalities have performed energy-saving steps. One such step is the use of regenerating-energy and use of energy-saving illumination means, such as LED lights. Although many devices are known to harness sunlight in order to power such illumination means, when it comes to illumination of large areas, it is still required to connect the lights to a main power grid, which makes installation harder and more costly.

Accordingly, the present invention provides a shading system equipped with an off-grid lighting system, that utilizes renewable-energy, thereby protecting the environment. Specifically, the present invention provides a shading system that provides shade during the day, during which it harnesses, e.g., the sunlight to produce electricity, and stores energy/electricity that is used during the night to power-up, e.g., LED light thereby providing illumination where needed without connecting to the main power grid. Embodiments of the invention further include illumination, shading, fixed and automatically adjustments of the shading system, while contributing to the reduction of carbon emissions, heavy metals and light pollution.

Furthermore, the redundance of power-grid connection reduces power consumption and aids in preventing overload power consumption, and eliminates the need of materials and labor that are required when usually connecting to the power-grid.

In certain embodiments, the shading sheets (101) of the invention are made of flexible material that is lightweight, easy to handle and enables flexibility during installation and adaptation to any shading-shape.

The terms “regenerating-energy”, “renewable-energy” and “green-energy” as used herein interchangeably refers to any energy type that is generated from natural resources, such as sunlight, wind or vibration, which do not produce pollution and do not harm the environment. As a source of energy, green-energy often comes from renewable-energy technologies such as solar energy, wind power, vibration, etc. The main sources are wind energy and solar power, which can be produced on a small scale at people's homes or alternatively, they can be generated on a larger, industrial scale.

Solar power is usually produced using photovoltaic cells that capture sunlight and turn it into electricity. It is an affordable and simple technique. Wind power uses the power of the flow of air to push turbines that then generate electricity. Vibration energy harvesting is the concept of converting vibration energy into electrical energy, which is possible through different known technologies, such as electromagnetic induction or Piezoelectric fibers. Solar, wind and vibration powers are considered as renewable, green and clean power sources since they come from an environmentally-friendly, self-replenishing and non-polluting source.

When assembling sunshades, one should take into consideration the sun's movement angle, the ground area that needs to be shaded and wind velocity. In general, the larger the ground area that needs to be shaded, the greater effect wind and gravity have on standard sunshades. When shading large ground areas, one should take into consideration the weight and rigidness of the material being used: hard material (e.g. plastic or polycarbonate pieces) is usually heavier than a flexible material (e.g. thin plastic yarn) and requires sturdier support. As a result, when shading large areas, massive constructions and/or multiple supporting anchors or mounting beams are needed to both prevent sinking of the sunshade sheets/pieces. In addition, the cost of the material and the overall construction also play a role, especially when large areas need to be shaded.

The terms “area” and “ground area” are used herein interchangeably to describe the area to be shaded, and refer to any area that can be walked on, including, but not limited to, actual ground, road, sidewalk, garden, field, balcony, terrace, rooftop, playing ground, etc.

Accordingly, the present invention provides a unique shading system that in addition to its ability to shade an area during the day, it can also illuminate the same area during the night, and that without being connected to the main power grid.

Specifically, the present invention provides a flexible shading system (100) for shading an area below, the system (100) comprising: (a) at least one flexible shading sheet (101); (b) at least one flexible illumination module (102) attached-to or embedded-within said at least one flexible shading sheet (101), and designed to illuminate said area below the shading system; and (c) at least one green-energy collecting module (103) designed to absorb environmental energy and convert same to electrical energy for powering said at least one illumination module, wherein said shading system (100) is designed to provide shade during daytime and illumination during nighttime without being connected to a power grid. In specific embodiments, the at least one green-energy collecting module (103) is attached-to or embedded-within the at least one flexible shading sheet.

The term “flexible” as used herein, e.g., with reference to a shading sheet, refers to the ability of the, e.g., shading sheet to change its shape without braking. Any suitable material can be used, such as, but not limited to, mesh, nets, nylon, a textile (including fabric), etc. For example, textiles usable can be made of polyester, polyester fibers, nylon, polyurethane (or other polymers), etc. The sheets may include carbon, Kevlar or metal fibers integrated therein for improving material strength and durability. The type of material can be determined according to need, desire, cost and other limitations. A single shading sheet can be constructed from different materials. In certain embodiments, the shading sheet further comprise or is made of illumination modules, such as LED integrated therewith, and/or comprise or made of energy generating modules, such as solar panels.

In specific embodiments of the flexible shading system (100) of the invention, the at least one green-energy collecting module (103) is integrated within the at least one flexible shading sheet (101). In alternative specific embodiments, the at least one flexible illumination module (102) is integrated within the at least one flexible shading sheet (101). In further alternative specific embodiments, both the at least one green-energy collecting module (103) and the at least one flexible illumination module (102) are integrated within the at least one flexible shading sheet (101). Notably, in any configuration the illumination and the energy collection modules do not compromise the system's flexibility.

Accordingly, in specific embodiments, the present invention provides a flexible shading system (100) for shading an area below, the system (100) comprising: (a) at least one flexible shading sheet (101); (b) at least one flexible illumination module (102) attached-to or embedded-within said at least one flexible shading sheet (101), and designed to illuminate said area below the shading system; and (c) at least one green-energy collecting module (103) designed to absorb environmental energy and convert same to electrical energy for powering said at least one illumination module, wherein said shading system (100) is designed to provide shade during daytime and illumination during nighttime without being connected to a power grid; and wherein said at least one green-energy collecting module (103) is integrated-within and/or attached-to said at least one flexible shading sheet (101), without compromising the flexibility of the said shading sheet (101).

A variety of assemblies may be coupled-to and/or embedded-in the flexible shading sheet. Coupling may be done in a single or in multiple layers on each face of the shading sheet. It is important to realize that in all the embodiments of the invention the shading sheet has at least a “shaded face”, facing an area that requires shading during the day and illumination during the night. Accordingly, coupled assemblies comprise one or more “solar energy collection module”, one or more “illumination module” and one or more electricity conducting assemblies for coupling this module to an “energy storage” module.

The term “flexible illumination module” as used herein refers to illumination modules that can change their shape according to the shape of the material they are attached-to or embedded-in, i.e. the flexible shading sheet. Non-limiting examples of such illumination modules are light emitting diodes (LEDs), organic LEDs (OLEDs), woven optical fibers, or any other light emitting devices, or any combination thereof. Notably, the illumination module(s) are attached-to or embedded-within the shaded face of the shading sheet such that they are designed to emit light and illuminate the area underneath the shading sheet. Notably, not all the area underneath the shading sheet is necessarily illuminated, and the design, type, amount, strength and location of the illumination module(s) determine the illumination pattern underneath the shading sheet. It should also be noted that the illumination module(s) attached-to or embedded-in the shading sheet does not impair its flexibility.

In certain embodiments, the present invention provides a shading array comprising a plurality of shading systems as described herein above, connected to one another, such that several shading systems in the array can use a single energy storage device and/or each shading system in the array can have the same or different energy collecting module that provide electricity to all the systems in the array. The number of shading systems in such an array can vary according to need and the area that needs to be shaded, and can be 2, 3, 4, 5, 6, 7, 8, 9, 10 or more.

In certain embodiments, the shading system (100) of the invention further comprises: (i) at least one energy storage module/unit designed to store electricity generated by said at least one green-energy collecting module (103), and use said stored energy for activating said at least one illumination module (102) during the nighttime and optionally a controller designed to control said at least one energy storage unit and/or said at least one flexible illumination module (102); (ii) at least one light sensor and at least one electric motor designed to automatically adjust the angle, position and/or direction of at least one of said at least one flexible shading sheets (101) according to the position/angle of the sun; and/or (iii) a motion sensor designed to activate the at least one flexible illumination module (102) when identifying the presence of an individual at the vicinity of said shading system (100), or any combination thereof.

In specific embodiments, the present invention provides a shading system (100) for shading an area below, the system (100) comprising: (a) one or more flexible shading sheets (101); (b) one or more flexible illumination modules (102) attached-to or embedded-within said at least one flexible shading sheet (101), and designed to illuminate said area below the shading system; (c) one or more green-energy collecting modules (103) designed to absorb environmental energy and convert same to electrical energy for powering said at least one illumination module; and (d) one or more energy storage units designed to store electricity generated by said at least one green-energy collecting module (103), and use said stored energy for activating said one or more illumination modules (102) during the nighttime and a controller designed to control said one or more energy storage unit and/or said one or more flexible illumination modules (102), wherein said shading system (100) is designed to provide shade during daytime and illumination during nighttime without being connected to a power grid). In further specific embodiments thereof, the system (100) further comprises a motion sensor designed to activate and/or control the power level of the one or more flexible illumination modules (102) when identifying the presence of an individual at the vicinity of said shading system (100).

In further or alternative embodiments, the system also comprises one or more light sensors and one or more electric motors, the sensors designed to track the sun's angle and the motors designed to automatically adjust the angle, position and/or direction of at least one of said one or more flexible shading sheets (101) according to the position/angle of the sun in order to, e.g., maintain an approximate shade area, subject to the sun angle. In specific embodiments, such sensors and electric motors receive electricity from the energy storage unit and/or directly from the energy collecting module. In specific embodiments, the adjustment of the shading sheets' angle and position can be manual (alone or in addition to automatic).

The term “energy storage unit” as used herein refers to any module that can store electricity, such as rechargeable batteries, of any type. In certain embodiments, the energy storage unit is integrated within the framing of the shading system (100) that holds the shading sheets (101). In specific embodiments, the energy storage unit can be positioned at the bottom of the framing, acting as an anchor/weight/stabler holding the entire system (100) in place against wind.

In certain embodiments, the transfer of energy from the energy collecting modules (103) to the illumination modules (102), can be done either directly, or indirectly, e.g., via the energy storing unit/device (104) of via a controller.

The adjustment of the flexible shading sheets (101) according to the position/angle of the sun has two main roles: the first role is to provide efficient shading to the area: as the sun moves across the sky during the day, the shade underneath a still cover moves and eventually becomes irrelevant since it shades an entirely different area, which is not required or needed to be shaded. Accordingly, movement of the shading sheets (101) in terms of right-to-left and/or up-and-down and/or tilting can improve shading coverage or the desired area to be shaded even when the sum moves during the day. An alternative approach, which does not require movement of the shading sheets (101), but requires lager amount of shading material, is the use of multilayered and angled sheets that are arranged such that they provide maximum shading in any angle of the sun. The second role is relevant when the energy collecting modules (103) are solar panels, in which case, the adjustment of the sheets' angle and direction can facilitate longer exposure to sunlight and improved production of electricity.

Accordingly, in certain embodiments of the shading system (100) of any of the embodiments above, the at least one green-energy collecting module (103) is flexible photovoltaic-cell(s)/solar-panel(s) attached-to or constitutes part-of said at least one flexible shading sheet's upper surface facing the sun and designed to convert light into electricity, wherein said module (103) does not compromise/impair the shading sheets' flexibility. Non-limiting examples of such photovoltaic-cell(s)/solar-panel(s) are photovoltaic cells, organic photovoltaic (OPV) cells, and Apollo Energy Film.

In certain embodiments, when the energy collecting modules (103) are not solar panels that are attached-to or part-of the shading sheets (101), but are alternative means, such as wind turbines, they can be mounted on, e.g., a rotating hinge that enables their rotation according to wind direction to enable generation of electricity even when the wind direction changes.

Accordingly, in certain embodiments of the shading system (100) of any of the embodiments above, the at least one green-energy collecting module (103) is wind turbine(s) designed to convert wind into electricity.

In certain embodiments of the shading system (100) of any of the embodiments above, the at least one green-energy collecting module (103) is one or more wind turbines integrated within the flexible shading sheet(s), in a way that they do not interfere with the flexibility of the shading sheet(s). In such a configuration, passage of air from one side of the sheet to the other via the wind turbines results in the conversion of wind into electricity by these turbines. Notably, such a configuration improves the aerodynamic properties of the shading system by reducing the effect wind has on the shading sheet, thereby improving the system's stability and durability to harsh weather.

In certain embodiments of the shading system (100) of any of the embodiments above, the at least one green-energy collecting module (103) is one or more vibration-energy harvester-based devices attached-to or constitute part-of said at least one flexible shading sheet and designed to convert vibration of the sheet (e.g. due to wind blowing, which shakes the flexible shading sheets) into electricity, wherein said devices do not compromise the shading system (100) flexibility.

In specific embodiments of the shading system (100) of any of the embodiments above, the at least one green-energy collecting module (103) comprises at least two of the following: (i) one or more flexible photovoltaic-cells/solar-panels attached-to or constitutes part-of said at least one flexible shading sheet's upper surface facing the sun and designed to convert light into electricity; (ii) one or more wind turbines designed to convert wind into electricity, optionally integrated within the flexible shading sheet's; and (iii) at least one vibration-energy harvester-based device attached-to or constitutes part-of said at least one flexible shading sheet and designed to convert vibration of the sheet (e.g. due to wind) into electricity.

In specific embodiments of the shading system (100) of any of the embodiments above, the at least one green-energy collecting module (103) comprises both one or more flexible photovoltaic-cells/solar-panels attached-to or constitutes part-of said at least one flexible shading sheet's upper surface facing the sun and designed to convert light into electricity, and one or more wind turbines designed to convert wind into electricity, optionally integrated within the flexible shading sheet's.

Accordingly, one of the purposes of the shading system (100) of the invention is to offer shading urban areas while utilizing natural energy in the shape of solar, wind and vibrations to provide illumination to these areas when needed.

The present invention further discloses a flexible outdoor lighting system, comprising: a flexible shading sheet usable for coupling illumination modules to a shaded face of the shading sheet; one or more illumination modules applicable for illuminating an area under and around the shaded face; and one or more electricity conducting assemblies for coupling said one or more illumination modules to an energy source. In addition, the system may further comprise: one or more energy collecting module for absorbing environmental/green-energy and converting absorbed energy to electrical energy, wherein the energy collecting module is coupled to an exposed face of the shading sheet, wherein the green-energy is solar energy, wind or vibration, or any combination thereof.

Reference will now be made to the accompanying figures, which are exemplary only and are not limiting the claimed scope.

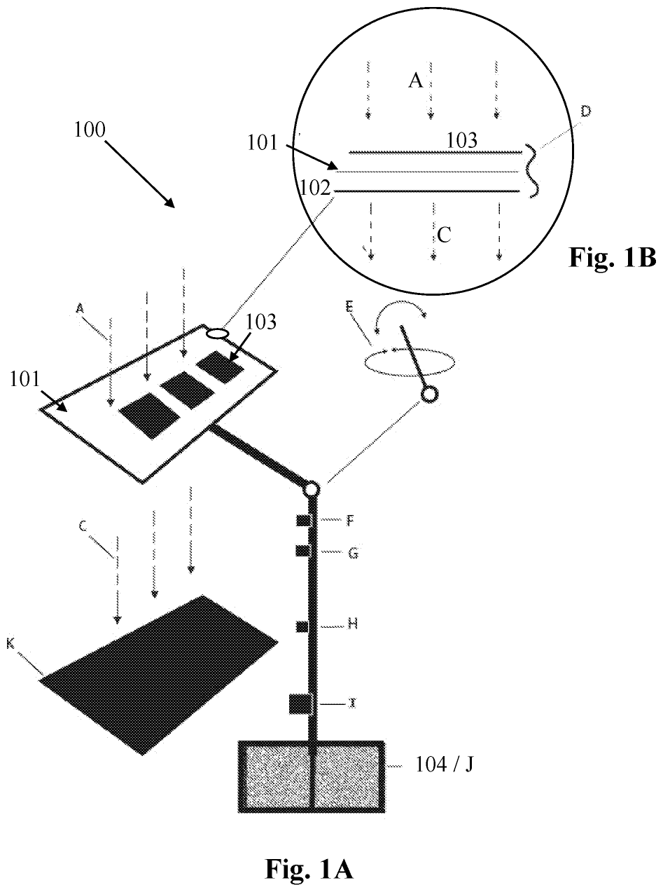

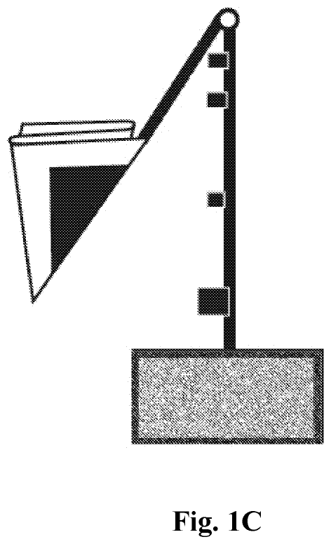

FIG. 1A illustrates a specific embodiment of the shading system (100) of the invention, comprising a single shading sheet (101) mounted onto a frame that is held by a single support leg. As seen in FIG. 1B, the shading sheet (101) comprises:

flexible shading sheet (101) with solar harvesting energy panels (103) on its upper surface facing the sun. When sunrays hit the upper surface of the shading sheets (A), the solar panels transforms them into electricity, which can then be used (preferably during the night when there is insufficient lighting) to activate illumination modules (102) underneath the shading sheet (C illustrates the illumination direction of the illumination modules).

FIG. 1A further illustrates that the shading system is stabilized by a lower base (J), which can optionally contain/hold/constitute a rechargeable battery used as an energy storage unit/device (104). In a specific embodiment, the battery is a salt-water battery that is embedded in the base and used a stabler. The energy storage device (104) is designed to be charged by the green-energy collecting module (103) (solar panels in this figure), optionally via a controller (I).

The energy storage unit/device (104) is designed to provide power/electricity to all the electric components of the system, such as the controller (I), optional outlet socket(s) (H) for, e.g., charging rechargeable devices like cellphones, motion sensor(s) (G), light sensor(s) (F) and electric motors for adjusting the shading sheets' angle/direction (E).

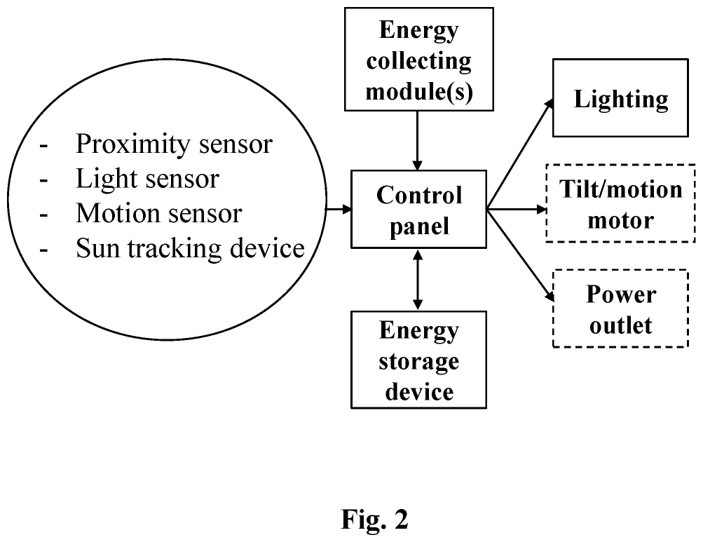

In certain embodiments, the energy storage device (104) is coupled directly, or indirectly through the controller, to all the electric components of the system by an electricity conductive material as illustrated in the flow chart in FIG. 2.

In certain embodiments, the light sensor (F) and the motion sensor (G) are connected to the controller (I) and based on information received therefrom the system determines when to activate the illumination modules (102), e.g. in correlation to ambient light level and human presence. For instance, when it gets dark, and the motion sensor identifies the presence of an individual near the shading system, the illumination module (102) is activated to provide light thereto. Once the motion sensor does not recognize any movement, indicative of absence of individuals, the illumination module is turned off to save power.

The electric motor(s) for adjusting the shading sheets' angle/direction (E) is used to adjust the tilt and/or location of the shading sheet (101), according to sun's angle. This is done by using a light sensor designed to identify the sunrays' angle and/or by identifying the relative angle/position of the shade underneath the shading sheet in order to maintain an optimal shaded area (K) in terms of area and position. The sun angle and/or shade movement is monitored by sensors connected to the system through a controller.

FIG. 1B illustrates a possible structure of the shading sheet, showing an infrastructure flexible shading sheet (101), an illumination module (102) at the sheets' lower/bottom section and a harvesting solar energy layer (103) at the sheets' upper section. Also is shown is an optional wind- or a vibration harvesting-module (D) that is integrated within the sheet (101).

FIG. 1C illustrates how the shading system of FIG. 1A can be folded when needed, e.g. when it is not needed, when it needs to be stored, and/or when there is a storm and it is advisable to fold the system to prevent it from breaking. Such folding is enabled due to the flexibility of the shading sheet and other components associate/with/connected-to it.

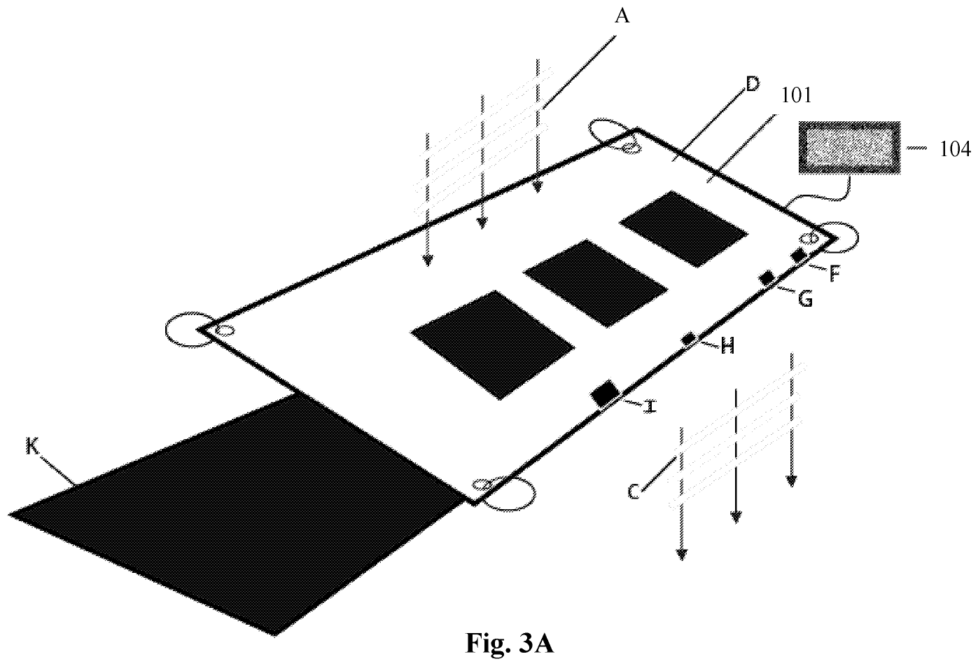

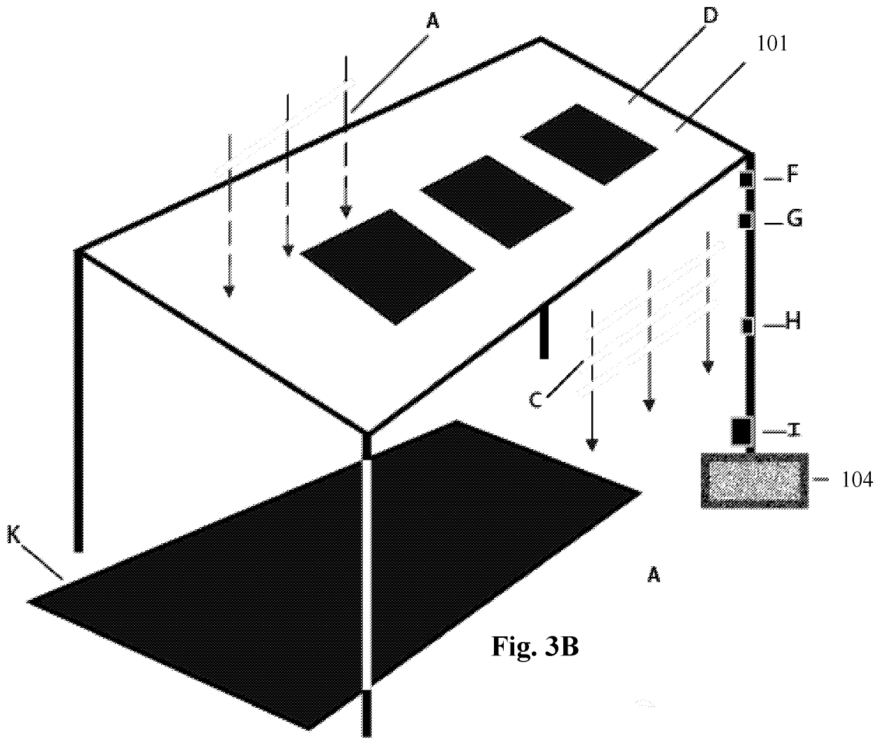

FIG. 3A illustrates another possible configuration of a shading system of the invention, showing a single flexible sheet that is designed to be connected via its corners to appropriate/adequate anchoring points/support. Notably, the number of anchoring points can vary according to need. Accordingly, the shading sheet can be anchored via 3, 4, 5, 6, 7, 8, 9, 10 or more anchoring points, i.e. in addition to the corners, additional points along the sides of the sheet. In addition, one or more anchoring points can be in the area/surface of the sheet (not its perimeter), e.g. by using a center pole placed underneath the sheet, pushing it upwardly to elevate the sheet. Accordingly, in certain embodiments, the shading system (100) of the invention according to any of the embodiments above further comprises (wall) fixation units for affixing the shading sheet(s) (101) to such a support(s). The type and number of the fixation units can vary according to the type of support to which the sheet is designed to be secured, and according to the number of required anchoring points.

FIG. 3B illustrates another possible configuration of a shading system of the invention, showing one or more flexible sheets that are stretched on a frame along its edges. Notably, the frame can have 1, 2, 3, 4, 5, 6, 7, 8 or more legs, depending on its size and other constructions' limitations. and more than four points can be used, such as additional points along the sides of the sheet. In addition, one or more anchoring points can be in the area of the sheet, e.g. by using a center pole placed underneath the sheet, pushing it upwardly to elevate the sheet is of a flexible sheet stretched on a frame. Notably, although the energy storage unit/device (104) is illustrated as the base of one of the construct's legs, it can be integrated into one or more of the contract's legs or frame, or can be buried in the ground near the construct.

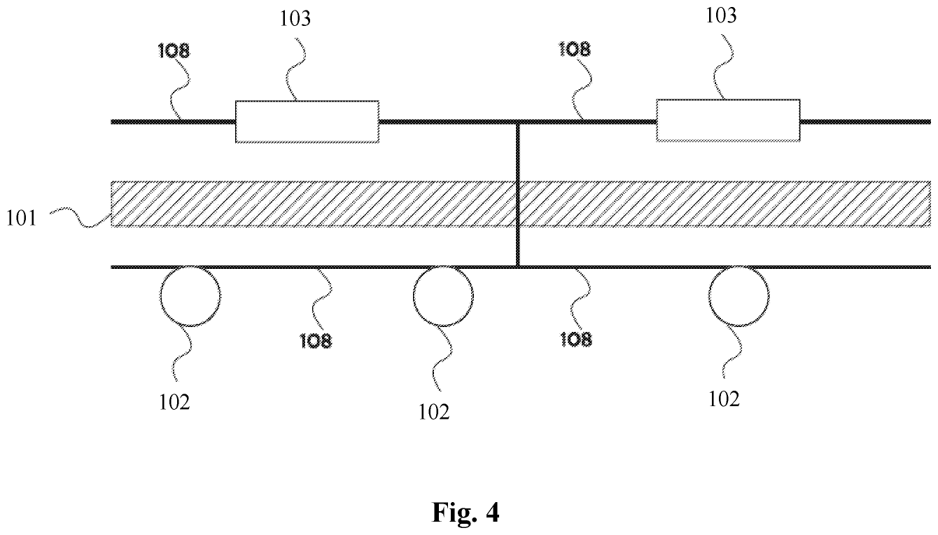

FIG. 4 illustrates a side-view enlargement of a shading sheet (101) according to some embodiments of the invention. As illustrated, the upper side of the shading sheet (101) that faces the sun, a couple of organic photovoltaic (OPV) cells (102) are attached, and on the lower side thereof, some illumination modules (102) are attached, all connected via electricity conducting assemblies (108). In this example the electricity conducting assemblies directly coupling the OPV cells (103) and the illumination modules (102). Alternatively, such a direct coupling is not the case, e.g., but is via a battery that collects the energy from the OPV cells (103), and optionally via a controller that controls the operation of the illumination modules (102).

As explained herein, the number (and type) of OPV cells and/or the number and type of the illumination modules can vary according to need. For example, as can be appreciated by a person versed in the art, a single OPV cell, which spreads essentially entirely all over the shading sheet can be used.

Further to understanding the general structure of embodiments of the invention, it can be further appreciated that when positioned outside, in sunlight, the shading sheet may mask sunlight from reaching an area relative thereto, thereby providing shade. For example, as illustrated in the schematic FIG. 5A, if the shading sheet (101) is positioned in an essentially horizontal manner directly perpendicular to the sunrays (204), shade (206) would be parallel to the shading sheet (101) and approximately equivalent in size. However, as illustrated in FIG. 5B, if the shading sheet (101) is positioned in diagonal to the sunrays (204), shade (206) would be the projection as can be understood by everyone versed in geometry.

The shaded area forms a climate-regulated environment, or in other words, the shading sheet (101) may form a canopy. Throughout dark hours, when the illumination modules (102) are turned on, the canopy is then used for lighting the projection thereof (resembling the shaded projections during the daytime, e.g., as seen in FIG. 5), therefore reducing dependency on standard outdoor lighting, such as light fixtures positioned on pillars, and therefore reducing the dependency on electricity supply. In other words, the shading system of the invention also acts as an off-grid lighting system.

Today, in existing outdoor lighting, national standards normally exist, to set requirements for outdoor lighting. For example, these standards may define the minimal lighting intensity (e.g., in Lux), as measured on ground level. It is known that a spot of light created on the ground gets wider as the height of a light fixture increases. Therefore, to continuously cover an area on the ground, existing outdoor lighting, where light fixtures are sparse on pillars, must use tall pillars. Moreover, because the light fixtures are installed on tall pillars, in order to achieve a predetermined intensity of lighting on the ground (as set, e.g., by existing standards), it can be appreciated that the intensity of the light fixtures must be high. The higher the position of the light fixture the higher should be the intensity.

Accordingly, in certain embodiments, the shading system of the invention is characterized by reducing light pollution compared to standard outdoor lighting systems. This is due to the fact that the illumination modules (102) are coupled to the lower/shaded face of the shading sheet (101), which is placed lower above the ground level compared to the height of standard lighting pillars. This further reduces the required intensity of the illumination modules compared to that required for standard light fixtures, which reduces both energy consumption requirements, light pollution, and overall costs. Moreover, since the shading sheet is opaque, light leakage from therearound is further reduced and is limited mainly to the near proximity of the shading system, thereby further reducing light pollution compared to standard outdoor lighting systems.

Light pollution can be further reduced, e.g., by folding the margins of the created canopy and/or by designing a parabolic-shaped canopy, etc. Generally, the form of the canopy my also reduce light pollution.

Accordingly, in certain embodiments of the shading system of the invention, the illumination modules (102) are installed/integrated on the lower-side of the shading sheet (101), the height of the canopy/shading sheet (101) is lower than the height of standard lighting pillars, i.e. between 2.5-4 meters, and the intensity of the illumination modules (102) is lower than that required in standard light fixtures, i.e. less than 40,000 Lumen.

In addition, because no lighting pillars are required since the illumination modules are coupled to the canopy/shading sheet, the illumination modules can be positioned close to each other. As a result, although the respective light beams of the illumination modules (102) cover a relatively small ground coverage, the fact that they are placed in close proximity to one another onto the shading sheet/canopy, they achieve good coverage at ground level.

The lower the intensity of the illumination modules, the lower would be the reflections returned from the ground and from particles in the air, therefore while reducing intensity, the light pollution would be reduced as well. When these reflections hit the canopy, their spread is reduced, thereby reducing light pollution even further.

Photovoltaic cells are operative in converting light energy into electrical energy during the day, and illumination modules are required/operative during dark hours. Accordingly, in certain embodiments, the shading system invention according to any of the embodiments above further comprises energy storing devices (such as rechargeable batteries and/or capacitors) designed to receive electricity generated by the photovoltaic cells (or any other green-energy collecting module (103)), and use the collected/stored energy during the night time for activating the illumination modules (102). The energy storing devices may be coupled to OPV cells and to the illumination modules.

In certain embodiments, the shading system according to any of the embodiments above further comprises one or more management modules/controllers. For example, during twilight a management module may set the lighting intensity to less than maximal intensity that is used during the dark hours. Alternatively, or additionally, when no people are present in vicinity of the system, the management module may reduce lighting intensity as well, or maybe turn lighting off, as applicable to the case, etc. The management module can be pre-programmed or online connected to a control center (optionally wirelessly).

In certain embodiments of the shading system according to any of the embodiments above, the coupling of the green-energy collecting module(s) (103), such as OPV cells, and the illumination modules (102) is done in layers. This means that the shading sheet (101) constitutes a main/first layer, onto-which or embedded-within, as additional layers, are both the green-energy collecting module(s) (103) and the illumination modules (102). For instance, when solar energy collecting module(s) are used, they are coupled on top of the shading sheet on the sun-exposed face, and constitute a “second layer”, and the illumination modules are coupled to the lower/shaded face of the shading sheet, and constitute a “third layer”. In some embodiments, electricity conducting assemblies may form a separate layer, which connects the different layers together, and hence, constitutes a “fourth layer” (of electricity conducting assemblies). Such a “fourth layer” may exist between the first and the third layer and/or between the first and second layer. Nevertheless, the green-energy collecting module(s) (103) and/or the illumination modules (102) may be combined in a layer with the electricity conducting assemblies. In such embodiments, the second layer may comprise OPV cells and electricity conducting assemblies, and/or the third layer may comprise illumination modules and electricity conducting assemblies.

Having a layers-based structure may allow separate manufacturing of each layer, and later coupling thereof to form an integrated system. Alternatively, layers can be printed on the shading sheet or combined therewith (e.g., by interweaved or by extrusion etc.) in a single production line.

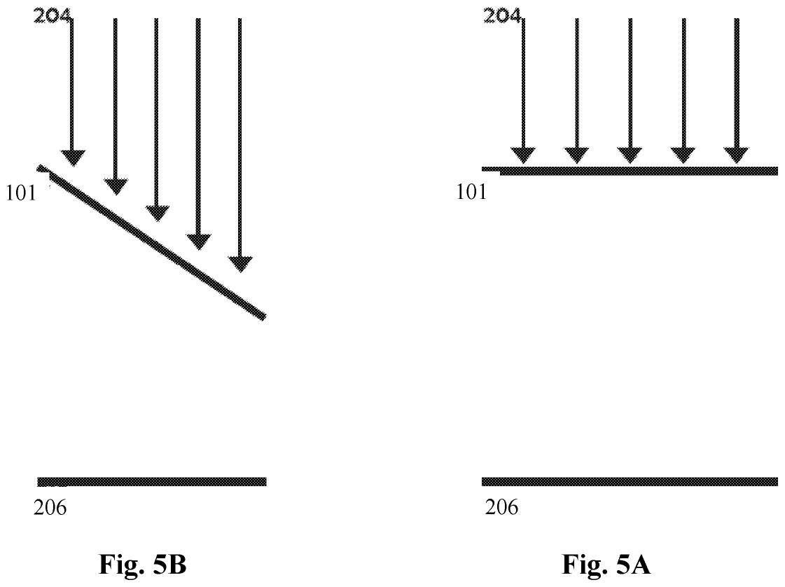

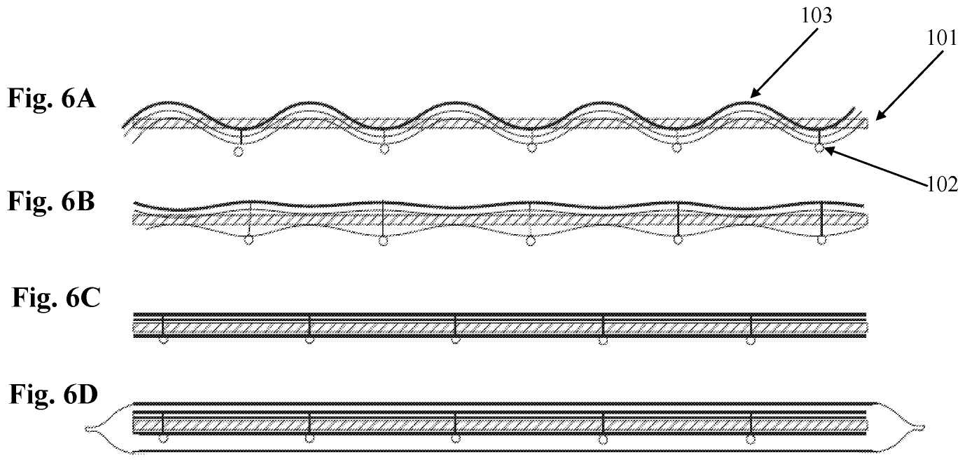

FIGS. 6A-6D schematically illustrate different options for coupling the shading sheet (101), OPV cells (103) and illumination modules (102) with electricity conducting assemblies. These options are brought as examples and other/additional options may exist if applicable.

FIG. 6A describes a shading sheet (101) into which a pre-made electricity conducting assembly is coupled by interweaving. OPV cells (103) are coupled to the electricity conducting assembly, e.g., by gluing, printing, welding, sewing, and/or by plagues, etc. This schematic description may be relevant also to illumination modules instead of (or in addition to) OPV cells. Notably, instead of interweaving the pre-made electricity conducting assembly and then coupling the OPV cells and/or illumination modules thereto, it is possible to interweave a pre-made electricity conducting assembly pre-combined with OPV cells and/or with illumination modules.

FIG. 6B describes a shading sheet (101) onto whose face a pre-made electricity conducting assembly is coupled. Coupling can be made, e.g., by using glue, welding, by sewing and/or by printing, etc., while OPV cells and/or illumination modules can be coupled to the electricity conducting assembly by any way applicable to the case (e.g., by gluing, printing, welding, sewing, by using plagues etc.). Notably, instead of coupling a pre-made electricity conducting assembly and then coupling OPV cells and/or illumination modules thereto, it is possible to couple a pre-made electricity conducting assembly pre-combined with OPV cells and/or with illumination modules.

FIG. 6C describes printing an electricity conducting assembly, while OPV cells and/or illumination modules can be coupled to the electricity conducting assembly by any way applicable to the case (e.g., by gluing, printing, welding, sewing, by using plagues etc.). Notably, instead of printing the electricity conducting assembly and then coupling the OPV cells and/or illumination modules thereto, it is possible to print an electricity conducting assembly and OPV cells and/or illumination modules.

FIG. 6D describes extruding an electricity conducting assembly, while OPV cells and/or illumination modules can be coupled to the electricity conducting assembly by any way applicable to the case (e.g., by gluing, printing, welding, and/or by using plagues etc.). Notably, instead of extruding the electricity conducting assembly and then coupling the OPV cells and/or illumination modules thereto, it is possible to extrude an electricity conducting assembly and OPV cells and/or illumination modules.

Further to understanding the different ways for coupling a shading sheet (101) to solar panels (103), such as OPV cells, illumination modules (102) and electricity conducting assembly, it is further explained that a system according to the invention should stand harsh conditions such as burning sun (high temperature, UV radiation etc.), winds and humidity (rain and/or other precipitations). In order to stand such harsh conditions, it is possible, in some embodiment, e.g., to laminate the shading sheet and other components attached-thereto/integrated-therewith and sealing the lamination (illustrated in FIG. 6D). In such embodiments, the lamination may be considered as forming an additional layer (exposed lamination layer and shaded lamination layer). Lamination can be applied by heat, ultrasonic welding or by any other applicable way.

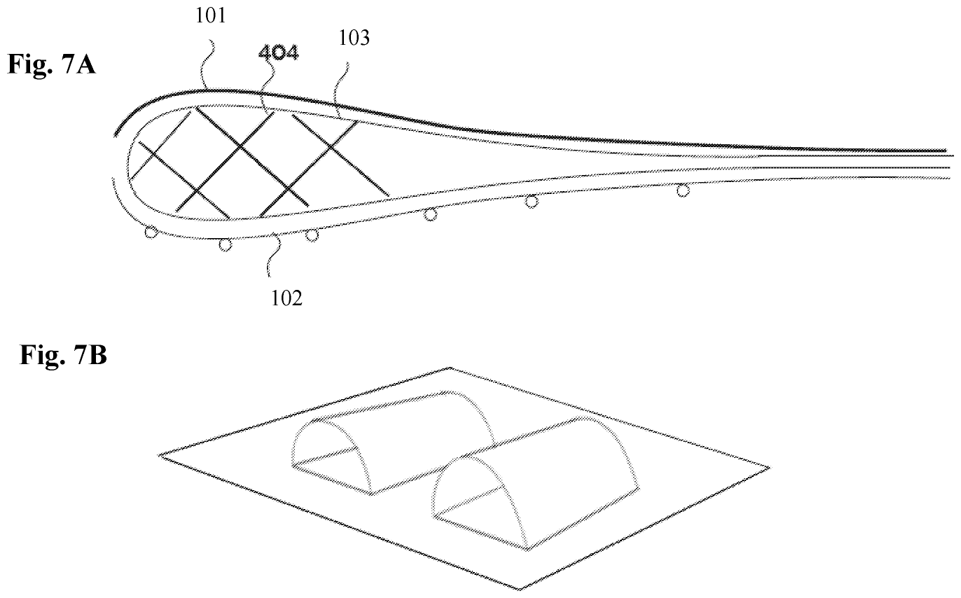

In certain embodiments, the shading system according to any of the embodiments above is manufactured in an aerodynamic manner so as to improve resistance to wind. This may apply to the shading sheet (101), the green-energy collecting modules (103), and/or the illumination modules (102). For example, as illustrated in FIG. 7A, it is possible to lay a shading sheet (101) in an aerodynamic form. Laying the shading sheet can be done, e.g., by stretching a textile around a rigid structure (404) while an OPV layer (103) and an illumination modules layer (102) are coupled thereto by any way applicable to the case. In such a specific embodiment, the exposed and the shaded faces of the shading sheet (101) constitute two different areas of the same face, unlike previous examples, e.g. as in FIG. 4, where the exposed face and the shaded face were on the two sides of the shading sheet (101).

FIG. 7B illustrates yet another aerodynamic form of the shading sheet, having hollow paths therein, allowing wind to blow therethrough. In specific embodiments, such holes can accommodate wind-turbines for harnessing wind power.

Unless otherwise indicated, all numbers used in this specification are to be understood as being modified in all instances by the term “about”. Accordingly, unless indicated to the contrary, the numerical parameters set forth in this specification are approximations that may vary by up to plus or minus 10% depending upon the desired properties to be obtained by the present invention.

1. A flexible shading system (100) for shading an area below, the system (100) comprising:
a) at least one flexible shading sheet (101);
b) at least one flexible illumination module (102) attached-to or embedded-within said at least one flexible shading sheet (101), and designed to illuminate said area below the shading system; and
c) at least one green-energy collecting module (103) designed to absorb environmental energy and convert same to electrical energy for powering said at least one illumination module,
wherein said shading system (100) is designed to provide shade during daytime and illumination during nighttime without being connected to a power grid; and wherein said at least one green-energy collecting module (103) is integrated-within and/or attached-to said at least one flexible shading sheet (101), without compromising the flexibility of the said shading sheet (101).

2. The shading system (100) of claim 1, wherein said at least one flexible illumination module (102) is integrated within said at least one flexible shading sheet (101).

3. The shading system (100) of claim 1, further comprising at least one energy storage unit (104) designed to store electricity generated by said at least one green-energy collecting module (103), and use said stored energy for activating said at least one illumination module (102) during the nighttime.

4. The shading system (100) of claim 3, further comprising a controller designed to control said at least one energy storage unit and/or said at least one flexible illumination module (102).

5. The shading system (100) of claim 1, further comprising at least one light sensor and at least one electric motor designed to automatically adjust the angle, position and/or direction of at least one of said at least one flexible shading sheets (101) according to the position/angle of the sun.

6. The shading system (100) of claim 1, further comprising a motion sensor designed to activate and/or control the power level of the at least one flexible illumination module (102) when identifying the presence of an individual at the vicinity of said shading system (100).

7. The shading system (100) of claim 1, wherein said at least one green-energy collecting module (103) is flexible photovoltaic-cell(s)/solar-panel(s) attached-to or constitutes part-of said at least one flexible shading sheet's upper surface facing the sun and designed to convert light into electricity, wherein said module (103) does not compromise the shading system (100) flexibility.

8. The shading system (100) of claim 1, wherein said at least one green-energy collecting module (103) is wind turbine(s) designed to convert wind into electricity.

9. The shading system (100) of claim 1, wherein wind turbine(s) is integrated within the shading sheet(s).

10. The shading system (100) of claim 1, wherein said at least one green-energy collecting module (103) is vibration-energy harvester-based device attached-to or constitutes part-of said at least one flexible shading sheet and designed to convert vibration of the sheet into electricity, wherein said device does not compromise the shading system (100) flexibility.

11. The shading system (100) of claim 1, wherein said at least one green-energy collecting module (103) comprises at least two of the following: (i) at least one flexible photovoltaic-cell/solar-panel attached-to or constitutes part-of said at least one flexible shading sheet's upper surface facing the sun and designed to convert light into electricity; (ii) at least one wind turbine designed to convert wind into electricity; and (iii) at least one vibration-energy harvester-based device attached-to or constitutes part-of said at least one flexible shading sheet and designed to convert vibration of the sheet (e.g. due to wind) into electricity.

12. A shading array comprising two or more shading systems (100) of claim 1.

13. The system of claim 1, wherein the power storage device is used as a mechanical stabler for the said system.
